(19) United States
(12) Patent Application Publication
(10) Pub. No.: US 2021/0056486 A1
(43) Pub. Date: Feb. 25, 2021

(54) PROCESS MANAGEMENT SYSTEM, PROCESS MANAGEMENT METHOD, AND PROCESS MANAGEMENT PROGRAM

(71) Applicant: YOKOGAWA ELECTRIC CORPORATION, Tokyo (JP)

(72) Inventors: Hiromi KAWAMUKAI, Tokyo (JP); Daisuke IKEGAMI, Tokyo (JP); Keita OGIWARA, Tokyo (JP); Yoshika HARASAKI, Tokyo (JP)

(21) Appl. No.: 17/092,315

(22) Filed: Nov. 8, 2020

Related U.S. Application Data
(63) Continuation of application No. PCT/JP2019/036861, filed on Sep. 19, 2019.

(30) Foreign Application Priority Data
Sep. 27, 2018 (JP) 2018-181110

(51) Int. Cl. G06Q 10/06; G06Q 50/04; G06K 7/10; G05B 19/418

(52) U.S. Cl. CPC G06Q 10/06316; G06Q 10/063114; G06Q 10/0633; G05B 19/41865; G06K 7/10475; G05B 19/41815; G06Q 50/04

(57) ABSTRACT

Development of a system capable of managing a process by using an instruction when manufacturing a product has been called for. A process management system is provided that includes an input unit that inputs process design data about a plurality of processes for manufacturing a product, an acquisition unit that acquires identification information of an instruction read by each of a plurality of readers, each provided for a corresponding one of the plurality of processes, in response to occurrence of an operation for the corresponding process, and a process management unit that performs management of the processes for manufacturing the product using the acquired identification information and based on the process design data.

### CROSS REFERENCE TO RELATED APPLICATION

This is a continuation application of International Application No. PCT/JP2019/036861, filed on Sep. 19, 2019, which claims priority to Japanese Patent Application No. 2018-181110, filed on Sep. 27, 2018, the contents of each of which are incorporated herein by reference in their entirety.

### BACKGROUND

### 1. TECHNICAL FIELD

The present invention relates to a process management system, a process management method, and a process management program.

### 2. RELATED ART

Conventionally, a part replenishment system that replenishes parts by using an instruction when manufacturing a product has been known (see Patent Document 1 for example).

Patent Document 1: Japanese Patent Application Publication No. 2008-139921

### SUMMARY

With the part replenishment system in PTL1, if a parts box is emptied when manufacturing a product, a worker can request for the part replenishment by putting an instruction with an IC tag, in the parts box, into a box. Yet, development of a system capable of managing a process by using an instruction when manufacturing a product has been called for.

To achieve the task described above, a first aspect of the present invention provides a process management system. The process management system may include an input unit that inputs process design data about a plurality of processes for manufacturing a product. The process management system may include an acquisition unit that acquires identification information of an instruction read by each of a plurality of readers, each provided for a corresponding one of the plurality of processes, in response to occurrence of an operation for the corresponding process. The process management system may include a process management unit that performs management of the processes for manufacturing the product using the acquired identification information and based on the process design data.

A second aspect of the present invention provides a process management method. The process management method may include inputting, by a process management system, process design data about a plurality of processes for manufacturing a product. The process management method may include acquiring, by the process management system, identification information of an instruction read by each of a plurality of readers, each provided for a corresponding one of the plurality of processes, in response to occurrence of an operation for the corresponding process. The process management method may include performing, by the process management system, management of the processes for manufacturing the product using the acquired identification information and based on the process design data.

A third aspect of the present invention provides a computer-readable medium storing a process management program. The process management program may be executed by a computer. The process management program may cause the computer to function as an input unit that inputs process design data about a plurality of processes for manufacturing a product. The process management program may cause the computer to function as an acquisition unit that acquires identification information of an instruction read by each of a plurality of readers, each provided for a corresponding one of the plurality of processes, in response to occurrence of an operation for the corresponding process. The process management program may cause the computer to function as a process management unit that performs management of the processes for manufacturing the product using the acquired identification information and based on the process design data.

### BRIEF DESCRIPTION OF THE DRAWINGS

FIG. 1 illustrates an example of process management performed when a product 110 is manufactured by using a process management system 170 according to the present embodiment.

FIG. 2 illustrates a flow of setting performed at the time of introduction, when the process management is performed by using the process management system 170 according to the present embodiment.

FIG. 3 illustrates an example where process design data is input to the process management system 170 according to the present embodiment.

FIG. 4 illustrates an example of setting data stored by the process management system 170 according to the present embodiment.

FIG. 5 illustrates a flow of process progress management by the process management system 170 according to the present embodiment.

FIG. 6 illustrates an example of a progress management widget provided by the process management system 170 according to the present embodiment.

FIG. 7 illustrates a flow for management of a staying time by the process management system 170 according to the present embodiment.

FIG. 8 illustrates a flow of management on an order of processes performed by the process management system 170 according to the present embodiment.

FIG. 9 illustrates an example of an alert widget provided by the process management system 170 according to the present embodiment.

FIG. 10 illustrates an example of a load balance widget provided by the process management system 170 according to the present embodiment.

FIG. 11 illustrates an example of a T matrix provided by the process management system 170 according to the present embodiment.

FIG. 12 illustrates an example of a computer 2200 in which a plurality of aspects of the present invention may be entirely or partially embodied.

### DETAILED DESCRIPTION OF EMBODIMENTS

The present invention is described below based on an embodiment of the invention. The embodiment described below does not limit the invention according to the scope of the claims. Not all combinations of features described in the embodiment are essential for the solution of the invention.

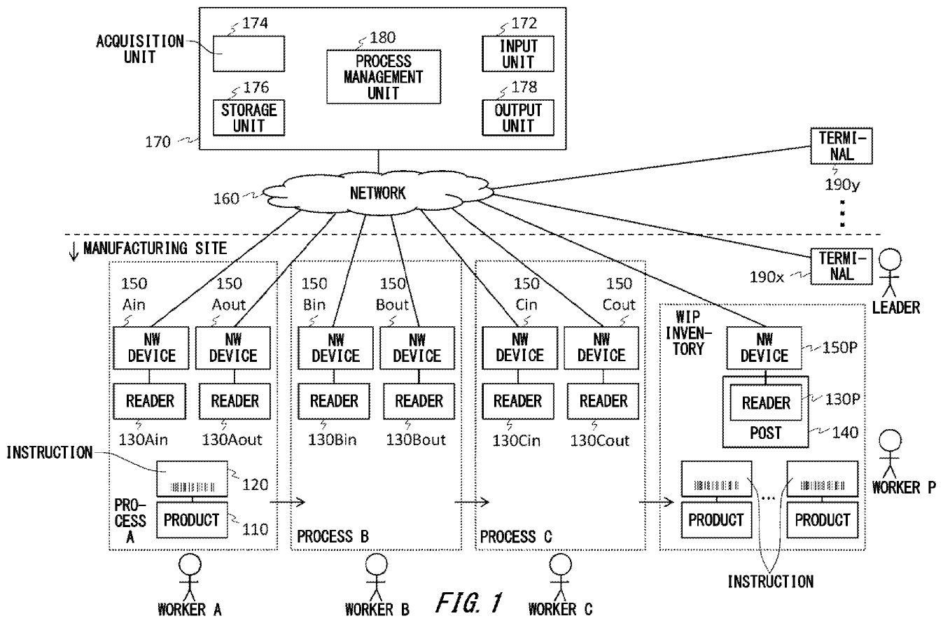

FIG. 1 illustrates an example of process management performed when a product 110 is manufactured by using a process management system 170 according to the present embodiment. The process management system 170 uses identification information of an instruction read by a plurality of readers 130 each provided to a corresponding one of a plurality of processes for manufacturing the product 110, to implement various types of process management such as process progress management, product stock management, quality management, and personnel adjustment. The process management system 170 according to the present embodiment is applicable to manufacturing in various industries such as metal product manufacturing, as well as manufacturing of electronic parts, devices and electronic circuits, plastic product manufacturing, lumber/wood product manufacturing, and food product manufacturing.

A manufacturing site includes a plurality of instructions 120, a plurality of readers 130Ain, 130Aout, 130Bin, 130Bout, 130Cin, 130Cout, and 130P (collectively referred to as “readers 130”), a post 140, and a plurality of network devices 150Ain, 150Aout, 150Bin, 150Bout, 150Cin, 150Cout, and 150P (collectively referred to as “network devices 150”).

The product 110 represents an article manufactured in the manufacturing site. The product 110 may be one or more finished products, a part of a finished product, or an intermediate product that is under manufacturing. For example, when the product 110 is a metal product, the product is subjected to a plurality of processes (a process A, a process B, and a process C in the figure), such as chamfering, bending, welding, painting, and cleaning, and then is stored as a work-in-process (WIP) inventory.

The instruction 120 is a slip that is issued for instructing an operation. The instruction is used for instructing various operations, and is, for example, a production instruction, a work commencement instruction, a shipping instruction, a transport (pickup) instruction, an order instruction, a delivery instruction, or the like. For example, the instruction 120 may be a kanban or the like formed of a thin steel plate, a piece of plastic, a card of laminated paper, or the like. For example, various items such as a product number, a product name, a process, a unit, and a lot may be written on the instruction 120.

In the present embodiment, the instruction 120 includes instruction identification information that is unique information with which the instruction 120 is identified with respect to other instructions. The identification information of an instruction may be a unique barcode (including a two-dimensional barcode) and/or character string printed on each instruction 120. Alternatively, an IC tag allocated with unique identification information (UID) may be attached to the instruction 120, or may be attached to a document folder or the like containing the instruction 120, so that the identification information (tag ID) of the IC tag is used as the identification information of the instruction. When the barcode or the like printed on the instruction 120 is used in conjunction with the IC tag, the tag ID of the IC tag may be associated with the unique barcode or the like printed on the instruction 120, and the tag ID of the IC tag may be used as the identification information of the instruction. Note that this IC tag may be a passive tag or an active tag, and may be used in any frequency band.

While the manufacture of the product 110 is in progress, a worker carries around the instruction 120 together with the corresponding product 110 so that the instruction 120 is always at the same location as the product 110. For example, the worker puts the instruction 120 and the corresponding product 110 in the same box or on the same tray, and transfers the product 110 between processes with these being in a contained state. In this case, the number of units corresponding to a single instruction 120 may be one or more than one. Thus, a single instruction may be associated with a single product 110 or with a plurality of products 110.

A plurality of the readers 130 are each provided for a corresponding one of the plurality of processes for manufacturing the product 110. Each process may be provided with a single reader 130, or may be provided with a plurality of readers 130. When each process is provided with a single reader 130, the number of readers 130 can be reduced, whereby the cost of equipment can be kept low. When each process is provided with a plurality of readers 130, for example, whether each process is in progress can be recognized by using different readers 130, so that process management can be performed in a more detailed manner, as described later. When a plurality of workers perform the same work in parallel, it is more preferable that the reader 130 is provided for each workbench, so that the work time can be managed for each worker as described later.

The reader 130 reads the identification information of an instruction. When a barcode is used as the identification information of the instruction, the reader 130 may be a barcode reader. When a tag ID is used as the identification information of the instruction, the reader 130 may be a tag reader. When a character string is used as the identification information of the instruction, the reader 130 may be constituted by an image sensor and an image recognition device.

In the figure, the reader 130 includes the reader 130Ain and the reader 130Aout provided in association with the process A, the reader 130Bin and the reader 130Bout provided in association with the process B, the reader 130Cin and the reader 130Cout provided in association with the process C, and the reader 130P provided in an area where the WIP inventory is stored.

For example, the reader 130Ain is an entrance side reader that is provided at an entrance of a work area for the process A for reading identification information of an instruction in response to start of an operation for the process A. Similarly, the reader 130Bin is an entrance side reader for the process B, and the reader 130Cin is an entrance side reader for the process C. These entrance side readers each automatically read the identification information of the instruction in response to passage of the product 110 and the instruction 120 through the entrance of the work area of each process when the operation for each process starts. Alternatively, a worker for each process may bring the instruction 120 close to the entrance side reader, to cause the entrance side reader to read the identification information of the instruction. In this case, the entrance side reader may read worker information identifying a worker for each process, by using an employee ID card or the like, for example. Thus, the process management system 170 can identify a person who performed an operation for the process, so that a work time or the like of each worker can be managed. In the description above, these entrance side readers are described to be each provided at the entrance of each work area. However, the entrance side reader does not necessarily need to be actually provided at the entrance of the work area, and may be provided at any position as long as the identification information of the instruction can be read in response to start of the operation for each process.

For example, the reader 130Aout is an exit side reader that is provided at an exit of the work area of the process A for reading identification information of the instruction in response to end of the operation for the process A. Similarly, the reader 130Bout is an exit side reader for the process B, and the reader Cout is an exit side reader for the process C. These exit side readers automatically read the identification information of the instruction in response to passing of the product 110 and the instruction 120 through the exit of the work area of each process, when the operation for each process ends. Alternatively, a worker for each process may bring the instruction 120 close to the exit side reader, to cause the exit side reader to read the identification information of the instruction. As in the case of the entrance side reader, the exit side reader does not necessarily need to be actually provided at the exit of the work area, and may be provided at any position as long as the identification information of the instruction can be read in response to end of the operation for each process.

The reader 130P is provided to the area storing the WIP inventory, and serves as a post-side reader for reading, when the product 110 is taken out (picking) from the area where it has been stored as the WIP inventory, the identification information of the instruction corresponding to the product 110 that is the target of the picking. The reader 130P may read the worker information for identifying a person who performed the picking, by using an employee ID card or the like, for example, as in the case of the entrance side reader. The word picking as used herein means an act of taking out from the inventory, and is also used as a word meaning shipping if the inventory is a finished product.

The post 140 is provided at the area storing the WIP inventory. When the product 110 is subjected to picking, the instruction 120 corresponding to the picking target product 110 is put into the post 140. The post 140 may be formed integrally with the reader 130P, which is the post-side reader, or may be formed separately from the reader 130P.

For example, when the product 110 is listed up on a picking list, a picking worker P goes to the area storing the WIP inventory to look for the product 110 listed up. Then, the picking worker P takes out the instruction 120 corresponding to the product 110 from the box or tray containing the product 110, and puts the instruction 120 thus taken out into the post 140. As a result, the reader 130P integrally formed with the post 140 for example reads the identification information of the instruction, and transmits the identification information of the instruction thus read to the process management system 170. Then, the picking worker P carries the product 110 out from the WIP inventory to another location. Thus, the process management system 170 can recognize that the picking worker P has performed the picking of the product 110 from the WIP inventory and carried it out to another location. In this case, when the picking list is provided in a tablet or the like, the process management system 170 may automatically put a check on the picking list indicating that the product 110 has been subjected to picking, in response to the picking worker P putting the instruction 120 into the post 140.

The network device 150 is a communication device that relays between a network in the manufacturing site and an external network 160. For example, the network device 150 is connected to the network 160 through a mobile phone communication network such as 3G or LTE, a Wireless Metropolitan Area Network (WMAN) such as WiMAX, or a wired network. For example, the network device 150 may be connected to a gateway through a Low Power, Wide Area (LPWA) communication network such as LoRa, and may be connected to the network 160 through the gateway. The readers 130 are connected to respective ports (USB ports, for example) of the network device 150, and the network device 150 provides the identification information of the instruction read by the readers 130 to the external network 160. The network device 150 and the readers 130 may be connected to each other in any mode, and may be wirelessly connected to each other by Wireless Local Area Network (WLAN) or the like, for example. In the figure, the network device 150 includes a network device 150Ain to which the reader 130Ain is connected, a network device 150Aout to which the reader 130Aout is connected, a network device 150Bin to which the reader 130Bin is connected, a network device 150Bout to which the reader 130Bout is connected, a network device 150Cin to which the reader 130Cin is connected, a network device 150Cout to which the reader 130Cout is connected, and a network device 150P to which the reader 130P is connected.

The network 160 is a communication network to which a plurality of computers or the like are connected to each other. The network 160 may be the Internet, for example.

The process management system 170 may be a server or the like formed by a computer, and may be a server system to which a plurality of servers are connected. The process management system 170 is connected to the network 160. When the network 160 is the Internet, the process management system 170 may be a Webserver, for example. The process management system 170 may be implemented by a cloud computing system. In such a case, the user can enjoy various types of services, provided by the process management system 170 on the cloud, in various Internet connectible environments.

The process management system 170 according to the present embodiment is connected to the network 160, and acquires the identification information of the instruction read by the readers 130 from the network device 150 through the network 160, to perform process management for manufacture of the product 110. The process management system 170 includes an input unit 172, an acquisition unit 174, a storage unit 176, an output unit 178, and a process management unit 180.

The input unit 172 inputs process design data of a plurality of processes for manufacturing the product 110. The input unit 172 receives a direct input from the user, for example, or inputs the process design data using a signal received via the network 160. The process design data input will be described later.

In response to the occurrence of each process, the acquisition unit 174 acquires the identification information of the instruction read by each of the plurality of readers 130 each provided for a corresponding one of the plurality of processes. The acquisition unit 174 acquires the identification information of these instructions from the plurality of network devices 150 that are provided for the plurality of respective readers 130 and are connected to the plurality of respective readers 130.

The storage unit 176 stores the process design data input by the input unit 172 and the identification information of the instructions acquired by the acquisition unit 174. Specific information stored in the storage unit 176 will be described later.

Through the network 160 such as the Internet, for example, the output unit 178 provides various types of information, obtained by the process management by the process management system 170, to users who can access the network 160.

The process management unit 180 uses the identification information of the instructions acquired by the acquisition unit 174, to perform process management for manufacture of the product 110 based on the process design data input by the input unit 172.

A terminal 190 may be a computer such as a personal computer (PC), a tablet computer, a smartphone, a workstation, a server computer, or a general purpose computer, and may be a computer system to which a plurality of computers are connected. In the figure, for example, the terminal 190 includes an in-site terminal 190x used in the manufacturing site and an out-of-site terminal 190y used outside the manufacturing site. These terminals are collectively referred to as the terminal 190, when they need not to be distinguished from each another.

The terminal 190 is connected to the network 160, and exchanges various types of information with the process management system 170 via the network 160. For example, the terminal 190 may transmit the process design data to the process management system 170 and cause the input unit 172 of the process management system 170 to input the process design data. The terminal 190 may receive various information obtained by the process management by the process management unit 180, via the network 160.

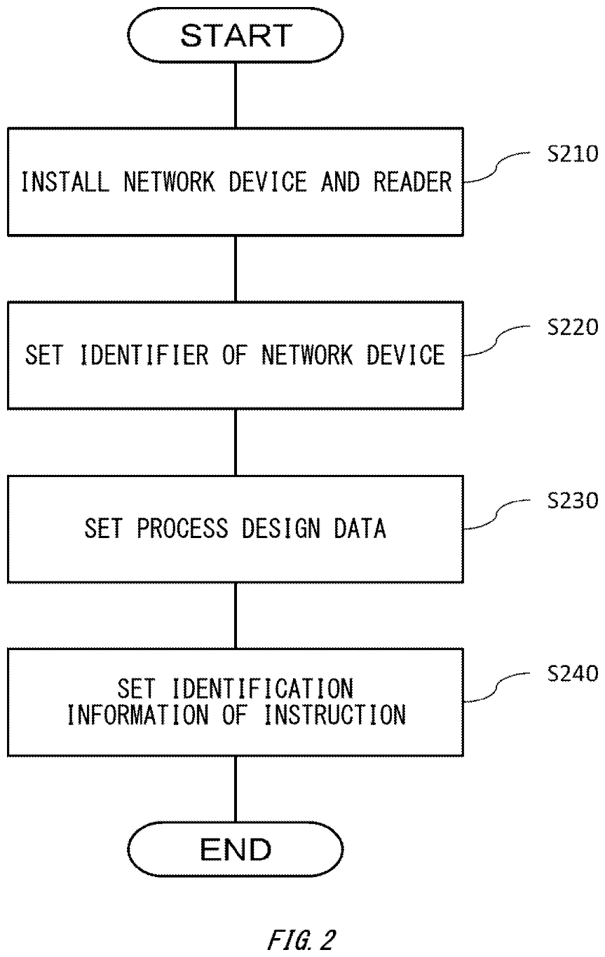

FIG. 2 illustrates a flow of setting performed at the time of introduction, when the process management is performed by using the process management system 170 according to the present embodiment. In step 210, the worker provides a plurality of network devices 150 in the manufacturing site, and sets the network devices 150 to be connectible to the network 160 via the mobile phone network, for example. In this process, the worker may set the network devices 150 by using a device registration application for a smartphone or the like, for example, to read a QR code (registered trademark) of the network devices 150. When the setting of the network devices 150 is completed, the worker then activates the network devices 150. The work provides the plurality of readers 130 each for a corresponding one of the plurality of processes, and connects each of the plurality of readers 130 to the port of the corresponding network device 150 through a cable, for example.

Next, in step 220, the process management system 170 sets identifiers of the network devices 150. For example, the process management system 170 receives a user operation from the terminal 190 on the network 160, for example, and sets information indicating that the identifier of the network device 150Ain is the identifier of the network device corresponding to the reader 130Ain, which is the entrance side reader for the process A. For example, the process management system 170 sets information indicating that the identifier of the network device 150P is the identifier of the network device corresponding to the reader 130P, which is the post side reader. In this manner, in step 220, the process management system 170 receives a user operation, and performs linking to set which of the identifiers of the plurality of network devices 150 is the identifier of the network device corresponding to which reader 130 of the plurality of readers 130 in the manufacturing site for which of the processes.

Next, in step 230, the process management system 170 sets the process design data. For example, the process management system 170 sets the process design data based on data input by the user operation from the terminal 190. Here, for example, the user can input the process design data through a Graphical User Interface (GUI) on a Webscreen. This will be described later.

Finally, in step 240, the process management system 170 sets the identification information of the instructions. For example, the process management system 170 receives a user operation from the terminal 190 on the network 160, and links the identification information of an instruction to a production number and/or a product name to identify which instruction 120 corresponds to which product 110. Furthermore, the process management system 170 sets the number of units corresponding to a single instruction 120 for each piece of identification information of an instruction. In addition, for example, the process management system 170 may link the identification information of an instruction with a lot number to identify which instruction 120 corresponds to which lot of which product 110. With the identification information of an instruction associated with a lot number, when the product 110 is manufactured, a location of a certain lot of a certain product 110 in the plurality of processes can be tracked. Furthermore, when a failure occurs, for example, a stage in the manufacturing can be traced back by tracing back the history.

In the description above, the case where the identification information of the instructions is set in the process management system 170 is described. However, alternatively, information linking the identification information of an instruction to a product number and/or a product name may be directly written to the IC tag itself In such a case, when the acquisition unit 174 acquires the identification information of the instruction, the process management system 170 may also acquire these pieces of information.

For example, when only a single product 110 is manufactured on a single line, when the worker clearly knows the association between the product 110 and the instruction 120, or in other like cases, the identification information of an instruction may not be linked with a product number and/or a product name in step 240.

When these settings are completed, the process management system 170 according to the present embodiment can start the process management for the manufacture of the product 110. Step 210 to step 240 in FIG. 2 are not limited to be set in the order illustrated in FIG. 2.

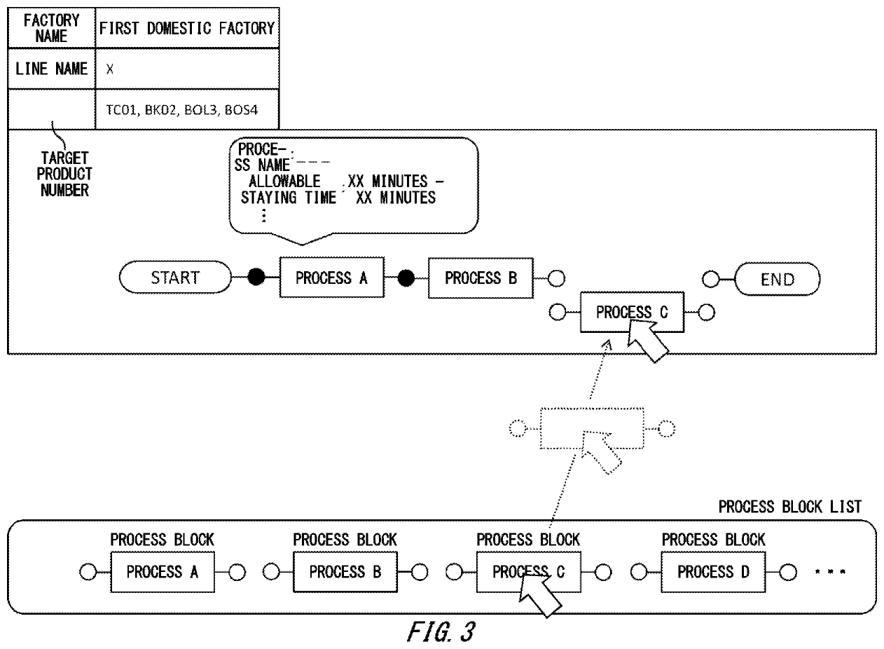

FIG. 3 illustrates an example where process design data is input to the process management system 170 according to the present embodiment. The user can input the process design data to the process management system 170 by using the terminal 190 on the network 160. For example, the process management system 170 displays the Webscreen as illustrated in the figure on the terminal 190, to induce the user to input the process design data. Then, for example, the user inputs a factory name, a line name, and a product number of the product 110 as a manufacturing target on the line, on the Webscreen. The user selects a relevant process block on a process block list via a GUI, and drags the process block onto a predetermined position on the screen. In this manner, the worker connects the process blocks to each other, to determine the order of a plurality of processes. In this process, the worker inputs the process name of each process and information required for each process such as allowable staying time via a pop-up screen displayed by clicking each process block. Thus, the process management system 170 sets process design data identifying what kind of product is manufactured in what process order, on which line in which factory, for example, based on the user operation via the GUI.

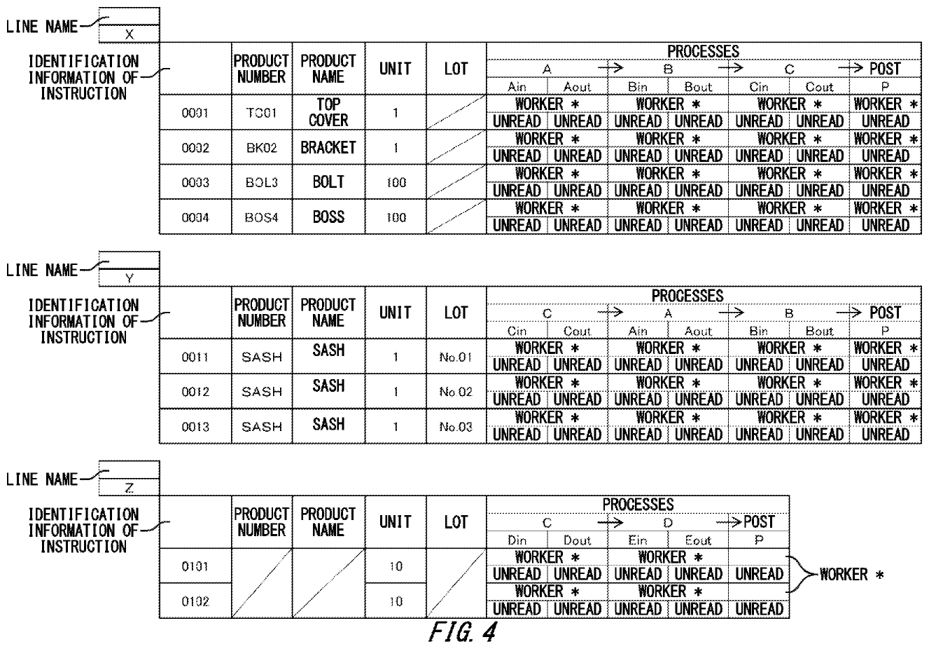

FIG. 4 illustrates an example of setting data stored by the process management system 170 according to the present embodiment. Through the flow illustrated in FIG. 2, the process management system 170 stores the setting data illustrated in the figure in the storage unit 176. For example, by step 220 in FIG. 2, the process management system 170 recognizes that Ain is the identifier of the network device corresponding to the input side reader for the process A, and that Aout is the identifier of the network device corresponding to the output side reader for the process A. Furthermore, by step 230 in FIG. 2, the process management system 170 recognizes that the process A is the first process on a line X, that the process B is the next process, and that the process C is the last process. The process management system 170 recognizes that TC01, BK02, BOL3, and BOS4 are the products to be manufactured on a line A. By step 240 in FIG. 2, for example, the process management system 170 recognizes that identification information=0001 of an instruction is linked to a product with a product number=TC01 and a product name=top cover, and that a single unit is linked to the instruction. The process management system 170 according to the present embodiment associates these pieces of data with each other, and stores the setting data illustrated in the figure. In the figure, “unread” indicates a state where the identification information of the instruction is not yet read by the reader 130. The process management system 170 according to the present embodiment performs the process progress management by changing “unread” in this field to “read” or to information indicating the read time information, when the manufacture of the product 110 starts and the reader 130 reads the identification information of the instruction.

The figure illustrates a case where the identification information of the instruction is linked to the product number and/or the product name but is not linked to the lot number on the line X. However, alternatively, the process management system 170 may link the identification information of the instruction to the product number, the product name, and the lot number as in the case of a line Y or may link the identification information of the instruction with none of the product number, the product name, or the lot number as in the case of a line Z.

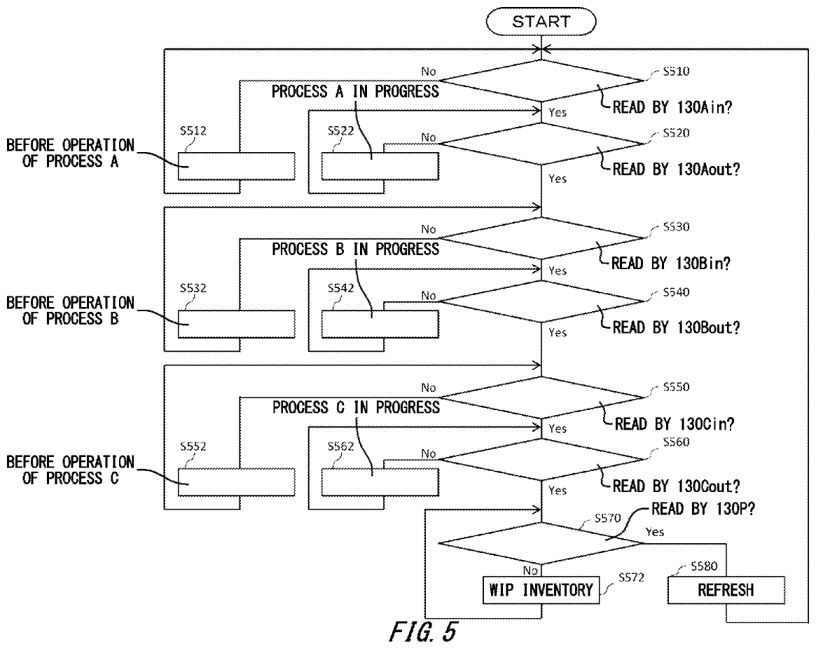

FIG. 5 illustrates a flow of process progress management by the process management system 170 according to the present embodiment. This figure illustrates processing executed on a single instruction 120. When a plurality of instructions 120 are used in the manufacturing site, the processing in this figure is executed on each of the instructions 120. When the manufacture of the product 110 starts, the process management system 170 acquires a message including the identification information of the instruction read by the reader 130 from the network 150 via the acquisition unit 174. The process management unit 180 of the process management system 170 uses the identification information of the instruction included in the message, to identify the product number, the product name, the unit, or the like of the product 110 from the information set in step 240 in FIG. 2. The process management unit 180 uses the product number identified, to identify the order of a plurality of processes for manufacturing the product 110 from the information set in step 230 in FIG. 2. For example, when the identification information of the instruction is 0001, the process management unit 180 identifies that the corresponding product 110 has the product number=TC01, the product name=top cover, unit=1, and the process order=A→B→C.

In step 510, for example, the process management unit 180 uses a transmission source address, included in the message acquired by the acquisition unit 174, for example, to identify the identifier of the network device 150, and determines whether the identification information of the instruction has been read by the reader 130Ain, which is the entrance reader for the first process. The network device 150 may transmit the message that indicates that the identification information of the instruction has been read and includes the identifier of the network device 150, and the process management unit 180 may use the identifier in the message to identify the identifier of the network device 150. When the reader 130Ain is determined to have not performed the reading in step 510, the process management unit 180 determines that the operation for the process A for the product 110 has not started yet, that is, determines that the stage is before the operation for the process A in step 512. Thus, the processing returns to step 510.

When the reader 130Ain is determined to have performed the reading in step 510, the process management unit 180 determines whether the reader 130Aout, which is the exit side reader for the process A, has read the identification information of the instruction in step 520. When the reader 130Aout is determined to have not performed the reading in step 520, the process management unit 180 determines that the operation for the process A for the product 110 has started but that the operation for the process A has not been completed yet, that is, determines that the operation for the process A is in progress in step 522. Thus, the processing returns to step 520. When a single reader 130 and a single network device 150 are provided to each process, the message received from the network device 150 for the first time may be used as a message indicating that the entrance side reader for the process has read the identification information of the instruction, and a message received from the network device 150 for the second time may be used as a message indicating that the exit side reader for the process has read the identification information of the instruction. Specifically, for example, when a single reader 130A and a single network device 150A are provided for the process A, a message received from the network device 150A for the first time may be treated as a message indicating that the entrance side reader for the process A has read the identification information of the instruction, and a message received from the network device 150A for the second time may be treated as a message indicating that the exit side reader for the process A has read the identification information of the instruction.

When the reader 130Aout is determined to have performed the reading in step 520, the process management unit 180 determines whether the entrance side reader for the next process, that is, the reader 130Bin has read the identification information of the instruction in step 530. When it is determined that the reader 130Bin has not read the information in step 530, the process management unit 180 determines that the operation for the process A for the product 110 has been completed, but the operation for the process B has not started, that is, determines that the stage is before the operation for the process B in step 532. Then, the processing returns to step 530.

When the reader 130Bin is determined to have performed the reading in step 530, the process management unit 180 determines whether the exit side reader for the process B, that is, the reader 130Bout has read the identification information of the instruction in step 540. When the reader 130Bout is determined to have not performed the reading in step 540, the process management unit 180 determines that the operation for the process B for the product 110 has started but that the operation for the process B has not been completed yet, that is, determines that the operation for the process B is in progress in step 542. Thus, the processing returns to step 540.

When the reader 130Bout is determined to have performed the reading in step 540, the process management unit 180 determines whether the entrance side reader for the next process, that is, the reader 130Cin has read the identification information of the instruction in step 550. When it is determined that the reading has not been performed in step 550, the process management unit 180 determines that the operation for the process B for the product 110 has been completed, but the operation for the process C has not started, that is, determines that the stage is before the operation for the process C in step 552. Then, the processing returns to step 550.

When the reader 130Cin is determined to have performed the reading in step 550, the process management unit 180 determines whether the exit side reader for the process C, that is, the reader 130Cout has read the identification information of the instruction in step 560. When it is determined that the reading has not been performed in step 560, the process management unit 180 determines that the operation for the process C for the product 110 has started but that the operation for the process C has not been completed yet, that is, determines that the operation for the process C is in progress in step 562. Thus, the processing returns to step 560.

When the reader 130Cout is determined to have performed the reading in step 560, the process management unit 180 determines whether the post side reader, that is, the reader 130P has read the identification information of the instruction in step 570. When it is determined that the reading has not been performed in step 570, the process management unit 180 determines that the operation for the process C, which is the last process for the product 110, has been completed but the picking has not been performed, that is, determines that the product 110 is in the stage of being stored as a WIP inventory in step 572. Then, the processing returns to step 570.

When the reader 130P is determined to have performed the reading in step 570, the process management unit 180 determines that the picking of the product 110 has been performed. Then, in step 580, the process management unit 180 refreshes the information related to the identification information of the instruction. For example, the process management unit 180 backs up information related to a history of the reader 130 that has read the identification information of the instruction in another area of the storage unit 176 and refreshes the information. Then, after the refreshing, the process management unit 180 links the instruction 120 to a different product 110 (a different lot with the same product number, for example), and resumes the processing from step 510 when the manufacture of the different product 110 starts. When the identification information of the instruction is used while being linked to a lot number, the link between the identification information of the instruction and the lot number may be updated in the refreshing in step 580.

In this manner, the process management unit 180 of the process management system 170 according to the present embodiment can use the identifier corresponding to the reader 130, out of the plurality of readers 130, that has most recently read the identification information of the instruction, to determine which stage, in the plurality of processes, the product 110 corresponding to the instruction 120 is on. In the present embodiment, each process is provided with the entrance side reader that reads the identification information of the instruction in response to the start of the operation for the process, and the exit side reader that reads the identification information of the instruction in response to the completion of the process. The process management unit 180 can use the identifiers corresponding to the entrance side reader and the exit side reader to determine whether each process for the product 110 corresponding to the instruction 120 is in progress.

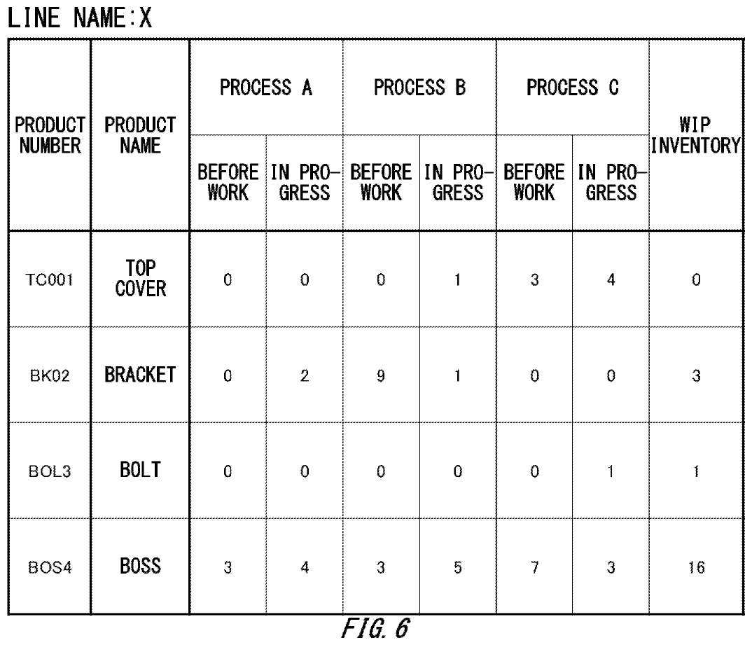

FIG. 6 illustrates an example of a progress management widget provided by the process management system 170 according to the present embodiment. The process management system 170 aggregates the progress status of the processes obtained by the flow illustrated in FIG. 5 for each product 110, to manage the progress status of the processes for each product 110. The process management system 170 can provide the progress management widget as illustrated in the figure to the terminal 190 on the network 160 via the output unit 178. Each number in the figure represents the number of instructions 120 in the corresponding stage of the plurality of processes. Thus, the figure illustrates an example where the number of instructions 120 linked to the top cover is one while the operation for the process B is in progress, is three before the operation for the process C, and is four while the operation for the process C is in progress. In the manufacture of the top cover, the number of units corresponding to a single instruction 120 is one. Thus, the figure indicates that there is one top cover while the operation for the process B is in progress, three top covers before the operation for the process C, and four top covers while the operation for the process C is in progress. The figure also illustrates an example where the number of instructions 120 linked to a bolt is one while the operation for the process C is in progress, and is one for the WIP inventory. In manufacture of a bolt, the number of units corresponding to a single instruction 120 is 100. Thus, the figure indicates that there are 100 bolts while the operation for the process C is in progress, and that there are 100 bolts in the WIP inventory.

A person who sees the progress widget illustrated in FIG. 6 can recognize that the top cover is currently not in the WIP inventory and thus is out of stock, but that four top covers are under the operation for the process C and thus will be completed soon. Furthermore, the person further recognizes that the brackets are concentrated on the stage before the operation for the process B, and thus that the bracket manufacturing is bottlenecked at the process B. Furthermore, the person can recognize that the bolts will be out of stock and thus run short soon, because there are only 100 bolts in the WIP inventory and there are only 100 bolts under operation. The person can recognize, for example, that a large number of bosses are in process and in the WIP inventory, and thus can recognize that the bosses are overstocked. The process management system 170 according to the present embodiment provides the progress management widget in accordance with these progress management statuses, and issues an alert in various situations, to notify the user of a situation such as an out of stock or overstock, for example.

As described above, with the process management system 170 according to the present embodiment, on which stage in the plurality of processes the product 110 is on can be determined, whereby the progress of the processes for the product 110 can be managed and a person who saw the progress management widget can be given a change to change the production management plan for the product 110. With the process management system 170 according to the present embodiment, whether the operation for each process for the product 110 is in progress can be determined, whereby the progress of the processes for the product 110 can be managed more in detail. When the process management system 170 is formed by a Webserver, various types of information can be provided to the user with the widget displayed on the terminal 190 in various environments inside or outside the manufacturing site, through the Internet.

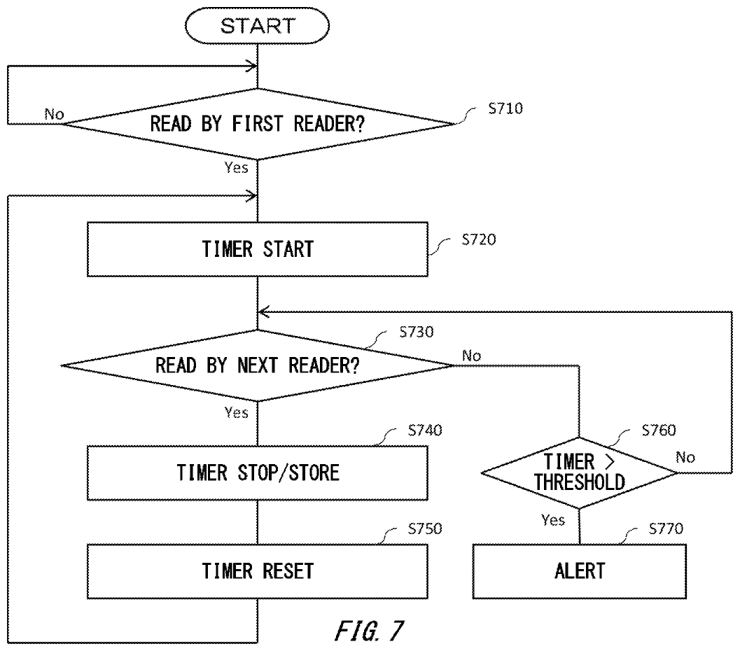

FIG. 7 illustrates a flow for management of a staying time by the process management system 170 according to the present embodiment. In step 710, the process management unit 180 of the process management system 170 determines whether the first reader 130 indicated by the process design data has read the identification information of the instruction. When the first reader 130 is determined to have read the identification information of the instruction in step 710, the process management unit 180 starts a timer in step 720.

Next, in step 730, the process management unit 180 determines whether the next reader 130 indicated by the process design data has read the identification information of the instruction. When the next reader 130 is determined to have read the identification information of the instruction in step 730, the process management unit 180 stops the timer in step 740, and stores the time on the timer as the staying time of the product 110 with respect to the instruction 120.

In step 750, the process management unit 180 resets the timer, and continues the processing, with the processing returned to step 720. On the other hand, when the next reader 130 is determined to have not read the identification information of the instruction in step 730, the process management unit 180 determines whether the timer exceeds a threshold (upper limit) in step 760. This threshold may be set in advance by the user for each process, as in the case of the allowable staying time described with reference to FIG. 3, may be set based on statistics such as an average of the staying times of the operations performed for the same process in the past, or may be set based on a simulation result or the like.

In step 760, when the timer does not exceed the threshold, the process management unit 180 continues the processing, with the processing returned to step 730. On the other hand, when the timer is determined to have exceeded the threshold in step 760, the process management unit 180 issues an alert in step 770. For example, when not only the upper limit but also a lower limit is set as the allowable staying time as illustrated in FIG. 3, the process management unit 180 may issue an alert when a value of the timer stopped in step 740 falls below the lower limit. Thus, the process management unit 180 can determine not only a delay of the process but also the advancement of the process.

As described above, the process management unit 180 of the process management system 170 according to the present embodiment calculates the staying time of the product 110 corresponding to the instruction 120, by using a time between the timing at which one reader 130 of the plurality of readers 130 reads the identification information of the instruction and the timing at which another one reader 130 of the plurality of readers 130 reads the identification information of the instruction. The process management unit 180 issues an alert when a predetermined range is overwhelmed by the time between reading of the identification information of the instruction by one reader 130 of the plurality of readers 130 and reading of the identification information of the instruction by another one reader 130 of the plurality of readers 130. Thus, with the process management system 170 according to the present embodiment, the staying time at each process is managed, so that which process takes how long can be presented to the user. When the reader 130 further reads the worker information as described above, the process management system 170 can provide a working time of each worker, to the user. Thus, the user can review the production management plan while taking the staying time for each process and the working time of each worker into consideration. Furthermore, the process management system 170 can identify the process that is excessively time-consuming, and thus enables the user to find trouble quickly or before it occurs.

Some manufacturing sites might run in a state where the identification information of an instruction and the product 110 are not associated with each other clearly in one-to-one relationship. For example, when 10 washers per unit are to be manufactured on the line Z in FIG. 4, two instructions 120 (with instruction IDs=0101 and 0102) might be provided to 20 washers without being distinguished from each other. In such a case, the process management system 170 may calculate an average waiting time and/or an average response time based on the queuing theory, and may issue an alert when these exceed a predetermined range. For example, the process management system 170 calculates an average service utilization rate p by dividing λ by μ, where λ represents an average arrival rate λ as an average value of the number of instructions 120 that arrive at the process per unit time and μ represents an average service rate as an average value of the number of instructions 120 processed in each process per unit time. The process management system 170 calculates an average waiting time Tw with a formula {ρ/(1−ρ)}*Ts, where Ts represents the waiting time for processing a single instruction 120. The process management system 170 calculates an average response time Tr with a formula {1/(1−ρ)*Ts}. Then, the process management system 170 may issue an alert when the average waiting time Tw and/or the average response time Tr exceeds a predetermined range.

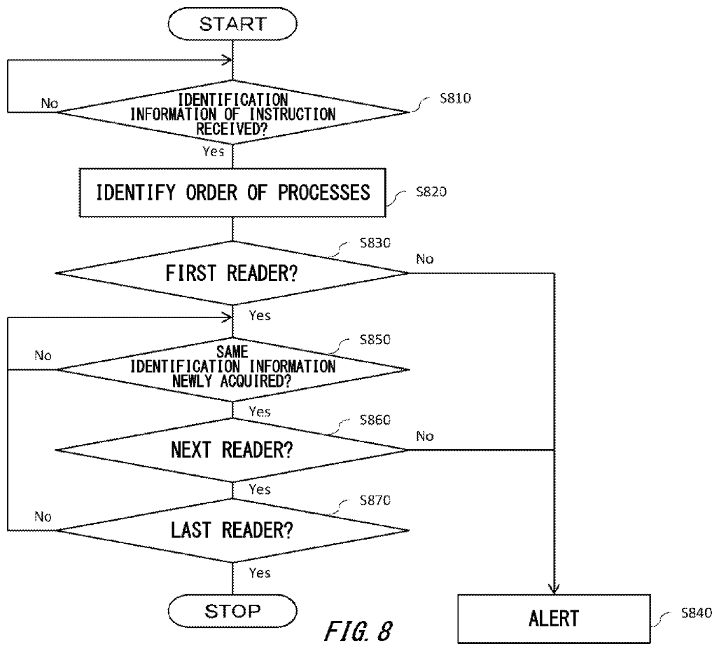

FIG. 8 illustrates a flow of management on an order of processes performed by the process management system 170 according to the present embodiment. The figure illustrates processing executed on a single instruction 120. When a plurality of instructions 120 are used in the manufacturing site, the processing in the figure is executed for each of the instructions 120. In step 810, the process management unit 180 of the process management system 170 determines whether a message indicating that the reader 130 has read the identification information of the instruction has been acquired from the network device 150. The process management unit 180 repeats 810, as long as no acquisition is determined in step 810.

When the message is acquired in step 810, in step 820, the process management unit 180 uses the identification information of the instruction included in the message acquired, to identify the order of the processes to be performed on the product 110 corresponding to the instruction 120, based on the process design data.

Then, in step 830, the process management unit 180 determines whether the reader 130 that has read the identification information of the instruction is the first reader 130 in the order of the processes identified in step 820.

When the reader 130 is determined not to be the first reader 130 in step 830, the process management unit 180 issues an alert indicating that the manufacture is not performed in the order of processes based on the process design data in step 840.

On the other hand, when the reader 130 is determined to be the first reader 130 in step 830, in step 850, the process management unit 180 determines whether a new message, indicating the reading of the identification information of the instruction that is the same as that in the message acquired in step 810, has been acquired from the network device 150. The process management unit 180 repeats the processing in step 850 as long as no acquisition is determined in step 850.

When the acquisition is determined in step 850, in step 860, the process management unit 180 determines whether the reader 130 that has read the identification information of the instruction is the next reader 130 in the order of processes identified in step 820.

When the next reader 130 is determined to have not read the information in step 860, in step 840, the process management unit 180 issues an alert indicating that the manufacture is not performed in the order of processes based on the process design data.

On the other hand, when it is determined in step 860 that the next reader 130 has read the information, in step 870, the process management unit 180 determines whether the reader 130 is the last reader 130 in the order of the processes identified in step 820.

When it is determined in step 870 that the reader 130 is not the last reader 130, the process management unit 180 continues the processing, with the processing returned to step 850. On the other hand, when it is determined in step 870 that the reader 130 is the last reader 130, the process management unit 180 determines that the manufacture of the product 110 corresponding to the instruction 120 has been properly conducted, and the processing is terminated.

As described above, the process management unit 180 of the process management system 170 according to the present embodiment can manage whether the manufacture of the product 110 corresponding to the instruction 120 is conducted in the order of processes based on the process design data, by using a history of the identifier of the reader 130 that has read the identification information of the instruction. Then, an alert is issued when the result of the determination is negative, so that the user can find trouble quickly or before it occurs. For example, conventionally, for an operation in the manufacture of the product 110, such as that for a cleaning process, involving no change in the appearance of the product 110 before and after the process, it has been difficult to find a missing process or the like in the manufacturing site. Still, with the process management system 170 according to the present embodiment, an alert is issued when such missing process occurs, whereby the product 110 can be prevented from being shipped without going through a required process.

Depending on the manufacturing site, the process design data may be reviewed while the manufacture of the product 110 is in progress, and thus different process design data may be employed for the same product 110 at a certain timing. Also in such a case, the process management system 170 according to the present embodiment manages whether the manufacture of the product 110 starting after the process design data was changed is performed in the order of processes based on the process design data after the change, and thus can flexibly support the reviewing of the process design data.

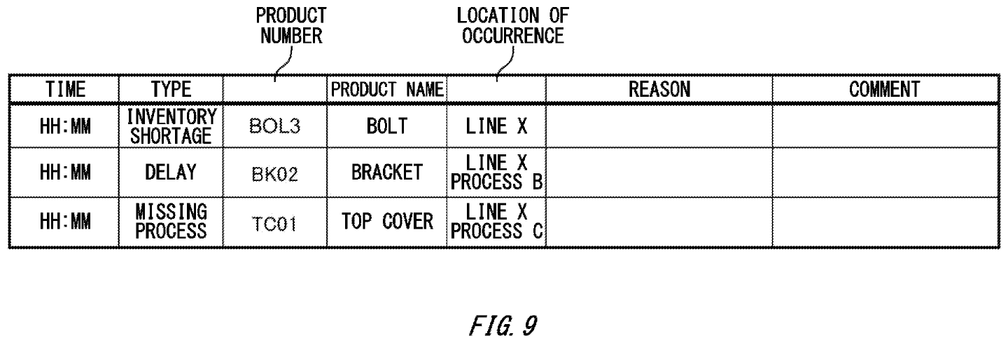

FIG. 9 illustrates an example of an alert widget provided by the process management system 170 according to the present embodiment. As illustrated in FIG. 9, the process management system 170 can provide on the terminal 190 on the network 160 via the output unit 178, an alert widget indicating what kind of alert has been issued for which product on which line. For example, the alert widget may include an occurrence location field indicating a location where the alert has occurred (such as which line and/or which process the alert has occurred). Furthermore, the alert widget may include a reason field where a worker of each process can input a reason for occurrence of the alert by using the in-site terminal 190x. The alert widget may further include a comment field where a leader of the manufacturing site can input a comment such as a countermeasure against the alert, by using the in-site terminal 190x.

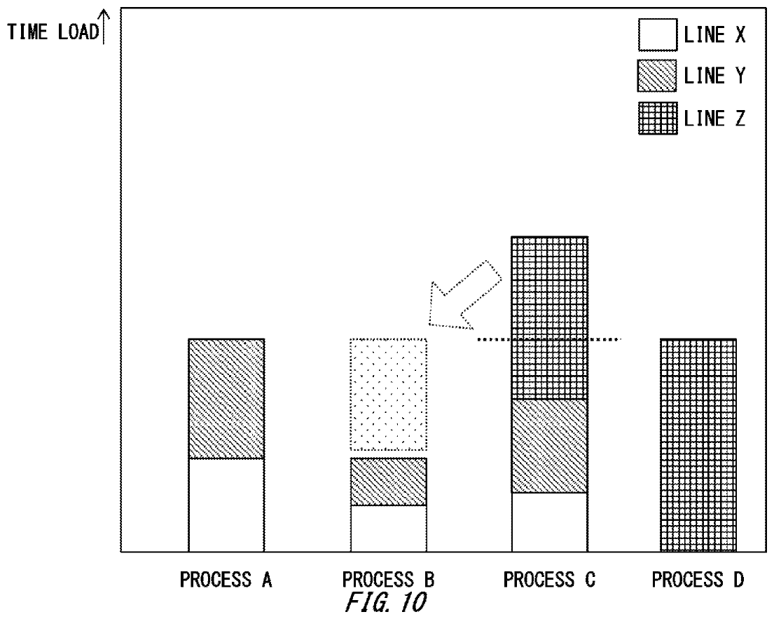

FIG. 10 illustrates an example of a load balance widget provided by the process management system 170 according to the present embodiment. For example, the process management system 170 calculates a time load for each process based on the staying time stored in the flow illustrated in FIG. 7. In this case, the process management system 170 may directly use the staying time, stored in the flow illustrated in FIG. 7, as the time load, may calculate the time load by performing statistic processing such as averaging, or may calculate the time load by performing calculation such as multiplication of a coefficient. Then, the process management system 170 accumulates the time loads on a plurality of lines for each process, to provide the load balance widget as illustrated in FIG. 10. The process management system 170 can display the load balance widget on a screen of the terminal 190 on the network 160, receive an input operation by the user via a GUI on the screen, and automatically generate a new production management plan based on the input operation. For example, a user who has recognized that the process C is in an overload state and that the process B is in an underload state by seeing the load balance widget as illustrated in the figure, clips a part of the time load accumulated for the process C via the GUI, and drags and drops the part to the process B. In response to this, for example, the process management system 170 can transfer some workers involved in the process B to the process C or perform other like operations, to automatically change the production management plan.

In this manner, the process management unit 180 of the process management system 170 according to the present embodiment uses the acquired identification information of the instruction to determine the load of each process, and can perform the process management for manufacture of the product 110 based on the determined load for each process. Furthermore, the process management unit 180 can receive an input operation on the screen displaying the load of each process, and determine personnel distribution for each process, based on the input operation. Thus, appropriate process management suitable for the load of each process can be implemented. Thus, with the process management system 170 according to the present embodiment, not only a planned load but also an actual load can be taken into consideration, so that the process management can be optimized with points that need to be improved figured out through comparison between the plan and the actual.

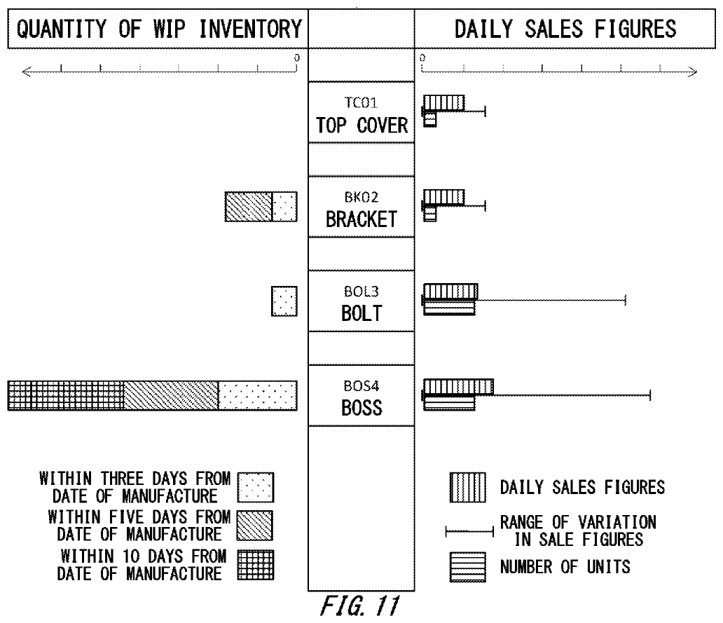

FIG. 11 illustrates an example of a T matrix provided by the process management system 170 according to the present embodiment. The process management system 170 provides a T matrix indicating the appropriateness of the inventory for each product as illustrated in FIG. 11, based on the progress status acquired in the flow illustrated in FIG. 5. For example, the T matrix in the figure has the left lateral axis representing the number of WIP inventories of each product 110, the right lateral axis representing daily sales figures of each product 110 (that is, the number of products taken out from the WIP inventory per day), and the vertical axis representing the types of the products 110, to indicate whether the number of inventories is appropriate relative to the sales figures for each product 110. Thus, with the process management system 170 according to the present embodiment, the T matrix as illustrated in the figure is automatically generated, whereby the user can be notified of the appropriateness of the inventories and thus can reduce unnecessary inventories. The process management system 170 may instruct the manufacture of the product 110 with an optimum production plan by predicting a range of variation in the sales figures from the past performance. The process management system 170 according to the present embodiment can cooperate with Manufacturing Execution System (MES), Robotic Process Automation (RPA), or the like to automate production management and/or back office processing, to improve operational efficiency of the manufacturing industry as a whole.

Various embodiments of the present invention may be described with reference to flowcharts and block diagrams whose blocks may represent (1) steps of processes in which operations are performed or (2) sections of apparatuses responsible for performing operations. Certain steps and sections may be implemented by dedicated circuitry, programmable circuitry supplied with computer-readable instructions stored on computer-readable media, and/or processors supplied with computer-readable instructions stored on computer-readable media. Dedicated circuitry may include digital and/or analog hardware circuits and may include integrated circuits (IC) and/or discrete circuits. Programmable circuitry may include reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

Computer-readable media may include any tangible device that can store instructions for execution by a suitable device, such that the computer-readable medium having instructions stored therein comprises an article of manufacture including instructions which can be executed to create means for performing operations specified in the flowcharts or block diagrams. Examples of computer-readable media may include an electronic storage medium, a magnetic storage medium, an optical storage medium, an electromagnetic storage medium, a semiconductor storage medium, etc. More specific examples of computer-readable media may include a floppy disk, a diskette, a hard disk, a random access memory (RAM), a read-only memory (ROM), an erasable programmable read-only memory (EPROM or Flash memory), an electrically erasable programmable read-only memory (EEPROM), a static random access memory (SRAM), a compact disc read-only memory (CD-ROM), a digital versatile disk (DVD), a BLU-RAY(RTM) disc, a memory stick, an integrated circuit card, etc.

Computer-readable instructions may include assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, JAVA, C++, etc., and conventional procedural programming languages, such as the “C” programming language or similar programming languages.

Computer-readable instructions may be provided to a processor of a general purpose computer, special purpose computer, or other programmable data processing apparatus, or to programmable circuitry, locally or via a local area network (LAN), wide area network (WAN) such as the Internet, etc., to execute the computer-readable instructions to create means for performing operations specified in the flowcharts or block diagrams. Examples of processors include computer processors, processing units, microprocessors, digital signal processors, controllers, microcontrollers, etc.

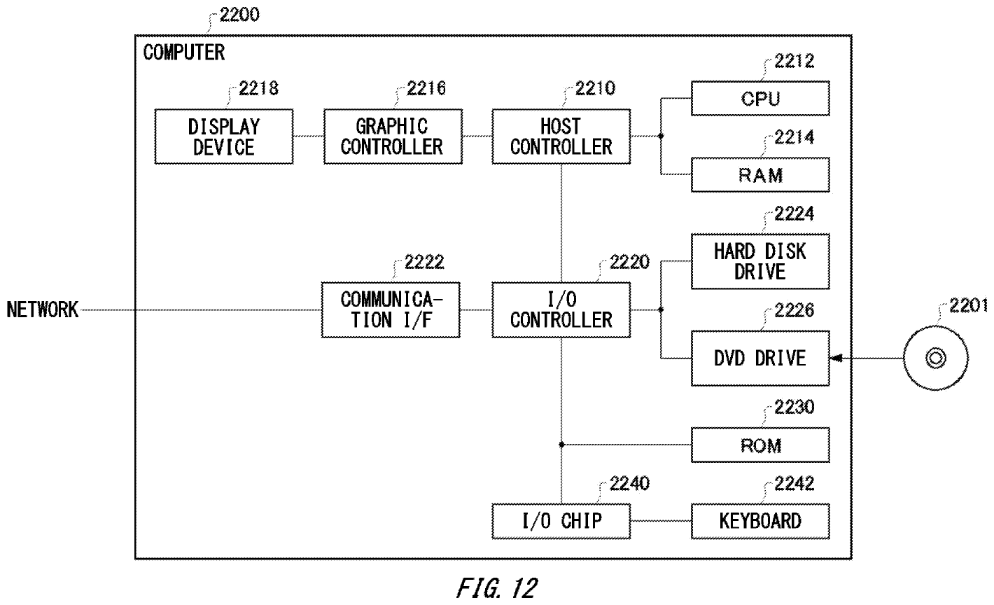

FIG. 12 shows an example of a computer 2200 in which aspects of the present invention may be wholly or partly embodied. A program that is installed in the computer 2200 can cause the computer 2200 to function as or perform operations associated with apparatuses of the embodiments of the present invention or one or more sections thereof, and/or cause the computer 2200 to perform processes of the embodiments of the present invention or steps thereof. Such a program may be executed by the CPU 2212 to cause the computer 2200 to perform certain operations associated with some or all of the blocks of flowcharts and block diagrams described herein.

The computer 2200 according to the present embodiment includes a CPU 2212, a RAM 2214, a graphics controller 2216, and a display device 2218, which are mutually connected by a host controller 2210. The computer 2200 also includes input/output units such as a communication interface 2222, a hard disk drive 2224, a DVD-ROM drive 2226 and an IC card drive, which are connected to the host controller 2210 via an input/output controller 2220. The computer also includes legacy input/output units such as a ROM 2230 and a keyboard 2242, which are connected to the input/output controller 2220 through an input/output chip 2240.

The CPU 2212 operates according to programs stored in the ROM 2230 and the RAM 2214, thereby controlling each unit. The graphics controller 2216 obtains image data generated by the CPU 2212 on a frame buffer or the like provided in the RAM 2214 or in itself, and causes the image data to be displayed on the display device 2218.

The communication interface 2222 communicates with other electronic devices via a network. The hard disk drive 2224 stores programs and data used by the CPU 2212 within the computer 2200. The DVD-ROM drive 2226 reads the programs or the data from the DVD-ROM 2201, and provides the hard disk drive 2224 with the programs or the data via the RAM 2214. The IC card drive reads programs and data from an IC card, and/or writes programs and data into the IC card.

The ROM 2230 stores therein a boot program or the like executed by the computer 2200 at the time of activation, and/or a program depending on the hardware of the computer 2200. The input/output chip 2240 may also connect various input/output units via a parallel port, a serial port, a keyboard port, a mouse port, and the like to the input/output controller 2220.

A program is provided by computer readable media such as the DVD-ROM 2201 or the IC card. The program is read from the computer readable media, installed into the hard disk drive 2224, RAM 2214, or ROM 2230, which are also examples of computer readable media, and executed by the CPU 2212. The information processing described in these programs is read into the computer 2200, resulting in cooperation between a program and the above-mentioned various types of hardware resources. An apparatus or method may be constituted by realizing the operation or processing of information in accordance with the usage of the computer 2200.

For example, when communication is performed between the computer 2200 and an external device, the CPU 2212 may execute a communication program loaded onto the RAM 2214 to instruct communication processing to the communication interface 2222, based on the processing described in the communication program. The communication interface 2222, under control of the CPU 2212, reads transmission data stored on a transmission buffering region provided in a recording medium such as the RAM 2214, the hard disk drive 2224, the DVD-ROM 2201, or the IC card, and transmits the read transmission data to a network or writes reception data received from a network to a reception buffering region or the like provided on the recording medium.

In addition, the CPU 2212 may cause all or a necessary portion of a file or a database to be read into the RAM 2214, the file or the database having been stored in an external recording medium such as the hard disk drive 2224, the DVD-ROM drive 2226 (DVD-ROM 2201), the IC card, etc., and perform various types of processing on the data on the RAM 2214. The CPU 2212 may then write back the processed data to the external recording medium.

Various types of information, such as various types of programs, data, tables, and databases, may be stored in the recording medium to undergo information processing. The CPU 2212 may perform various types of processing on the data read from the RAM 2214, which includes various types of operations, processing of information, condition judging, conditional branch, unconditional branch, search/replace of information, etc., as described throughout this disclosure and designated by an instruction sequence of programs, and writes the result back to the RAM 2214. In addition, the CPU 2212 may search for information in a file, a database, etc., in the recording medium. For example, when a plurality of entries, each having an attribute value of a first attribute associated with an attribute value of a second attribute, are stored in the recording medium, the CPU 2212 may search for an entry matching the condition whose attribute value of the first attribute is designated, from among the plurality of entries, and read the attribute value of the second attribute stored in the entry, thereby obtaining the attribute value of the second attribute associated with the first attribute satisfying the predetermined condition.

The above-explained program or software modules may be stored in the computer readable media on or near the computer 2200. In addition, a recording medium such as a hard disk or a RAM provided in a server system connected to a dedicated communication network or the Internet can be used as the computer readable media, thereby providing the program to the computer 2200 via the network.

The present invention is described using the embodiment, but the technical scope of the present invention is not limited to the scope in the embodiment described above, it should be clear to a person skilled in the art that the embodiment described above is susceptible to various modifications or improvements. It should also be dear from the scope of the claims that forms having such modifications or improvements can be included in the technical scope of the present invention.

The order of each processing in the operations, procedures, steps, stages, and the like of the devices, systems, programs, and methods in the scope of the claims, specification, and drawings is not specifically disclosed using “beforehand”, “in advance”, and the like, and any order is possible as long as subsequent processing does not use an output from preceding processing. Even if “first”, “next”, and the like are used for convenience in describing the flow of operations in the scope of the claims, specification, and drawings, it is not meant that the operations need to be executed in this order.

### REFERENCE SIGNS LIST

110 Product
120 Instruction
130 Reader
140 Post
150 Network device
160 Network
170 Process management system
172 Input unit
174 Acquisition unit
176 Storage unit
178 Output unit
180 Process management unit
190 Terminal
2200 Computer
2201 DVD-ROM
2210 Host controller
2212 CPU
2214 RAM
2216 Graphic controller
2218 Display device
2220 Input/output controller
2222 Communication interface
2224 Hard disk drive
2226 DVD-ROM drive
2230 ROM
2240 Input/output chip
2242 Keyboard

What is claimed is:

1. A process management system comprising:
an input unit that inputs process design data that defines a process order of a plurality of processes for manufacturing a product;
an acquisition unit that acquires identification information of an instruction read by each of a plurality of readers, each provided for a corresponding one of the plurality of processes, in response to occurrence of an operation for the corresponding process; and
a process management unit that performs management of the processes for manufacturing the product using the acquired identification information and based on the process design data, wherein
the process management unit sequentially determines whether a reader provided for a corresponding one of the plurality of processes has read the identification information of the instruction in the process order defined by the process design data, and
the process management unit issues an alert when determining, by using a history of readers that have read the identification information, that manufacture of the product corresponding to the instruction is not being performed in an order of processes based on the process design data.

2. The process management system according to claim 1, wherein the process management unit uses an identifier corresponding to one of the plurality of readers that has most recently read the identification information, to determine which stage, in the plurality of processes, a product corresponding to the instruction is on.

3. The process management system according to claim 2, wherein
each of the processes is provided with an entrance side reader and an exit side reader, the entrance side reader to read the identification information in response to start of an operation for the process, the exit side reader to read the identification information in response to end of the operation for the process, and
the process management unit uses identifiers corresponding to the entrance side reader and the exit side reader to determine whether an operation for each of the processes is in progress for the product corresponding to the instruction.

4. The process management system according to claim 1, wherein the process management unit uses a time between reading of the identification information by one reader of the plurality of readers and reading of the identification information by another reader of the plurality of readers, to calculate a staying time of the product corresponding to the instruction.

5. The process management system according to claim 4, wherein the process management unit issues an alert when the time between the reading of the identification information by the one reader and the reading of the identification information by the another reader exceeds a predetermined range.

6. The process management system according to claim 1, wherein the process management unit uses the acquired identification information to determine a load of each of the processes, and performs the management of the processes for manufacturing the product based on the determined load of each of the processes.

7. The process management system according to claim 6, wherein the process management unit receives an input operation on a screen displaying the load of each of the processes, and determines personnel distribution for each of the processes based on the input operation.

8. The process management system according to claim 1, wherein the acquisition unit acquires the identification information of the instruction from a plurality of network devices including an entrance side network device each provided to and connected to a corresponding entrance side reader and an exit side network device each provided to and connected to a corresponding exit side reader.

9. The process management system according to claim 8, wherein
an identifier of the entrance side network device is an identifier of the network device corresponding to the entrance side reader, and
an identifier of the exit side network device is an identifier of the network device corresponding to the exit side reader.

10. A process management method in which a process management system manages processes, the process management method comprising:
inputting, by the process management system, process design data that defines a process order of a plurality of processes for manufacturing a product;
acquiring, by the process management system, identification information of an instruction read by each of a plurality of readers, each provided for a corresponding one of the plurality of processes, in response to occurrence of an operation for the corresponding process; and
performing, by the process management system, management of the processes for manufacturing the product using the acquired identification information and based on the process design data, wherein
the performing management of the processes includes sequentially determining whether a reader provided for a corresponding one of the plurality of processes has read the identification information of the instruction in the process order defined by the process design data, and
the performing management of the processes includes issuing an alert when determining, by using a history of readers that have read the identification information, that manufacture of the product corresponding to the instruction is not being performed in an order of processes based on the process design data.

11. A computer-readable medium storing a program that, when executed by a computer, causes the computer to function as:
an input unit that inputs process design data that defines a process order of a plurality of processes for manufacturing a product;
an acquisition unit that acquires identification information of an instruction read by each of a plurality of readers, each provided for a corresponding one of the plurality of processes, in response to occurrence of an operation for the corresponding process; and
a process management unit that performs management of the processes for manufacturing the product using the acquired identification information and based on the process design data, wherein
the process management unit sequentially determines whether a reader provided for a corresponding one of the plurality of processes has read the identification information of the instruction in the process order defined by the process design data, and
the process management unit issues an alert when determining, by using a history of readers that have read the identification information, that manufacture of the product corresponding to the instruction is not being performed in an order of processes based on the process design data.

12. The process management system according to claim 1, wherein the instruction is a single instruction.

13. The process management system according to claim 4, wherein the process management unit issues an alert when a time between reading of the identification information by one reader and a reading of the identification information by a next reader indicated by the process design data exceeds a predetermined range.

14. The process management system according to claim 1, wherein the process order is changeable via a user input.
